(19) United States
(12) Patent Application Publication
(10) Pub. No.: US 2004/0039816 A1
(43) Pub. Date: Feb. 26, 2004

(54) Monitoring method of the remotely accessible resources to provide the persistent and consistent resource states

(75) Inventors: Myung M. Bae, Pleasant Valley, NY (US); Jose E. Moreira, Yorktown Heights, NY (US); Ramendra K. Sahoo, Jefferson Valley, NY (US)

Correspondence Address: Lawrence D. Cutter, Attorney, IBM Corporation, Intellectual Property Law Dept., 2455 South Rd., M/S P386, Poughkeepsie, NY, 12601, US

(73) Assignee: International Business Machines Corporation, Armonk, NY

(21) Appl. No.: 10/227,254

(22) Filed: Aug. 23, 2002

(51) Int. Cl. G06F 15/173

(52) U.S. Cl. 709/225

(57) ABSTRACT

Proxy Resource Managers are deployed on data processing nodes having full resource management support. Proxy Resource Agents are deployed on remote nodes without this support. The status and attributes of a wide range of resources are kept consistent through the use of a system-wide Resource Generation Number whose initiation and maintenance is coordinated through communications between the Proxy Resource Manager and the Proxy Resource Agent. Resources managed and controlled herein include files, programs, devices and entire compute nodes.

### BACKGROUND OF THE INVENTION

The present invention is directed to distributed, multinode data processing systems. More particularly, the invention is directed to a mechanism for managing a plurality of diverse resources, whose presence on remote external data processing nodes can lead to situations in which their status is either changed, unknown or not well defined. Even more particularly, the present invention is directed to a method which employs proxy resource managers and a proxy resource agents, which together coordinate the maintenance and reporting of generation numbers, time stamps or other sequentially orderable indicia associated with specified resources, so that their status is provided in a consistent fashion across the distributed system.

In distributed systems, many physical or logical entities are located throughout the entire system of nodes. These entities include resources, whose use is sought by and from other system nodes. However, it is the nature of distributed systems to exhibit a highly heterogeneous structure with a wide variety of resources being present on different nodes. In order to provide maximum flexibility in system configuration and utilization, access is often made to remote nodes, which may or may not include desired levels of support for the resources, that are present at these remote nodes. Nonetheless, the status of these resources comprise important information for programs running on nodes, which do in fact include desired infrastructure support for more advanced levels of resource management.

In the context of the present invention, these remote entities are referred as “resources.” The term “resource” is employed very broadly herein to refer to a wide variety of both software and hardware entities. Examples of resources include “ether net device eth0 on node 14”, a database table called “Customers”, “Internet Protocol (IP) address 9.117.7.21”, etc. Each resource has at least one attribute, which defines the characteristics of that resource. Moreover, some of the attributes are reflected through a status or condition for the resource. As an example, an ethernet network device includes attributes like “name” (e.g., eth0), OpState (for example, Up, Down, Failed, Idle, Busy, Waiting, Off line, etc.), its address (e.g., 9.117.7.21), etc. Thus, “name,” “OpState,” and “address” are referred to as resource attributes. Many of the resource attributes are dynamic, which reflect the fact that changes in resources status occur frequently and for a large variety of reasons, which are often unknown to other nodes in the distributed system. For example, for the case of the ethernet network device mentioned above, “Opstate” is categorized as a dynamic attribute.

Since many of these remote resources often need to provide their services to some other components of the distributed system (for example, to system management tools or to end user applications), they need to be monitored and/or controlled. In the present context, the system that usually performs this function, is generally referred as the “Resource Management Infrastructure” (RMI). In operation, the RMI “assumes” that the resources referred to above are contained within or are confined to the same node, in which the RMI is running. However, because of software, hardware or architectural limitations, it is assumed that the resources are available on the same node when an RMI fails, even if some of the distributed system have different type of nodes, which may or may not contain the resources and the RMI.

The present invention proposes a mechanism to monitor and control remotely accessible resources, which exist on non-RMI nodes through the concept of “Proxy Resource Managers” (PxRM) and “Proxy Resource Agents” (PxRA). A Proxy Resource Manager is located on a node, which runs the RMIs (that is, which has an appropriate level of resource management support) and communicates with Proxy Resource Agents which are provided on external or remote node(s).

Although the aforementioned “Proxy Manager/Agent” mechanism supports the control and monitoring of remote resources, it also has some limitations the mechanism, that by itself it may not be always able to provide a consistent level of information concerning some of the dynamic attributes alluded to above (as for example the “up/down” status of a resource). For example, this deficiency may occur on a node, if the node on which the Proxy Resource Manager is restarted due to a node failure. The indicated infrastructure may report the attributes of a resource as either “failed” or “unknown,” even if the resource manager is restarted, because the restarted Proxy Resource Manager does not “know” the previous resource status and it also does not “know” whether the resources were up or down during the failure of the Proxy Resource Manager. Furthermore, a Proxy Resource Manager operating under the indicated infrastructure may not provide the correct attribute values, if the Proxy Resource Manager and the Proxy Resource Agent are disconnected and thereafter reconnected. Accordingly, the present invention further proposes a safer and more reliable method for providing persistent and consistent attribute and status information, even if there is a failure or restart of the Proxy Resource Manager. This goal is at least partially achieved by including the use of “generation numbers” in the Proxy Resource Agent. This is explained more fully in the detailed description provided below.

Use of the present invention provides a number of advantages, including, but not limited to the following: (1) resources on external devices on non-RMI nodes are more reliably monitored and controlled; (2) the method employed is still able to use existing RMIs without rewriting infrastructure code; and (3) the invention also provides consistent monitoring of the resource attributes, even if there is a node failure and/or one or more restarts of the Proxy Resource Manager, and even if there is a failure of the connection between the Proxy Resource Manager and/or the Proxy Resource Agent is unreliable. The present method also provides a means for handling a very large number of resources in a cluster system, by delegating the load to the remote nodes (which run PxRA).

### SUMMARY OF THE INVENTION

In accordance with a preferred embodiment of the present invention a method is provided for managing a remotely accessible resource in a multinode, distributed data processing system. On a first node of the distributed data processing system one runs what is referred to herein as a Proxy Resource Manager. This first node is coupled to a persistent storage device, on which is maintained a table containing a sequential resource generation identifier (generation number), which is associated with a resource present on a remotely accessible node, which may or may not include a Resource Management Infrastructure. The Proxy Resource Manager communicates with a Proxy Resource Agent running on the remote node. The Proxy Resource Agent maintains therein a local version of the aforementioned table further including attribute and/or status information concerning resources present on the remote node. This latter table also includes a locally generated version of the generation number associated with the resource together with a status indication for the resource. The generation number stored in the persistent storage device is incremented when the first node is restarted, say after a node failure. The remotely stored generation number is incremented upon change in resource status. The local and persistent generation numbers for the resource are compared at desirable times for insuring consistency amongst the nodes in the distributed system.

Accordingly, it is an object of the present invention to provide a method of managing resources on remote nodes in a distributed data processing system.

It is also an object of the present invention to provide consistent views of resource status throughout a multinode, distributed data processing system.

It is a further object of the present invention to avoid the need for providing complex resource management infrastructures and code therefor on remote data processing nodes.

It is another object of the present invention to increase the reliability and availability of both computational and other resources in distributed data processing systems.

It is a still further object of the present invention to provide better recovery from node and communications failures in distributed data processing systems.

It is yet another object of the present invention to improve the monitoring and control of resources present on the remote nodes in distributed systems.

It is also object of the present invention to promote the use of the Proxy Resource Management/Agent model in controlling remote resources, particularly through the use of a generation number (or similar indicia) to insure system wide consistency in resource characterization.

Lastly, but not limited hereto, it is object of the present invention to provide system-wide control and monitoring functions for use in distributed data processing systems in which a wide array of varied resources is accommodated and made available as widely as possible throughout the system for as much of the time as possible.

The recitation herein of a list of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention, is particularly pointed out and distinctly claimed in the concluding portion of the specification. The invention, however, both as to organization and method of practice, together with further objects and advantages thereof, may best be understood by reference to the following description taken in connection with the accompanying drawings in which:

FIG. 1 is a schematic diagram illustrating the environment in which the present invention is employed together with an indication of the locations of the components of the present invention and an indication of their interactions; and

FIG. 2 is a schematic diagram similar to FIG. 1 but more particularly illustrating the presence and use of the present invention and its components in a more complex and advanced environment where its usefulness is more fully met.

### DETAILED DESCRIPTION OF THE INVENTION

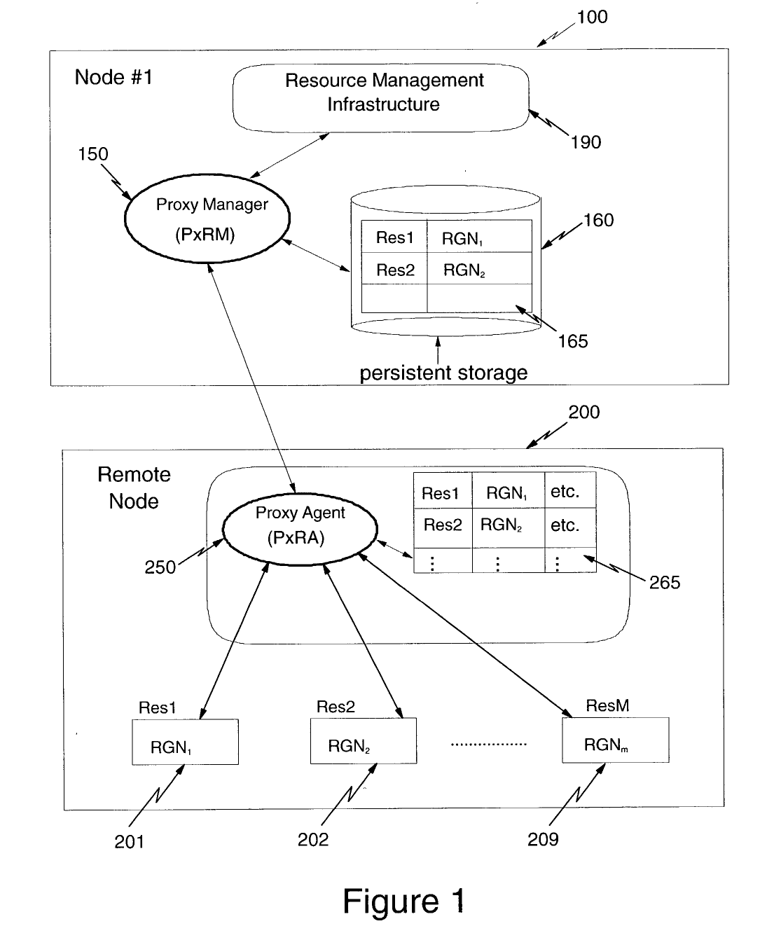

FIG. 1 illustrates the structure and operation of the present invention. In particular, it is seen that node 100 includes an existing level of what is referred to herein and below as Resource Management Infrastructure (RMI) 190. Also included on node 100 is Proxy Resource Manager 150 which communicates with RMI 190. Proxy Resource Manager 150 creates and maintains Table 165 on persistent storage device 160 which is coupled to node 100, either directly or indirectly through other nodes. Table 165 provides an association between Resource Generation Numbers (RGN₁, RGN₂, . . . ) and a plurality of remote resources (Res1, Res2, . . . ) which are found at remote node 200 as Resource #1 (Res1, reference numeral 201), Resource #2 (Res2, reference numeral 202), . . . , Resource #M (ResM, reference numeral 209). Remote node 200 may or may not include a resource management function such as RMI 190 as provided at node 100. However, it is an advantage of the present invention that this function is not needed at the remote nodes, such as node 200. It is further noted that FIG. 1, for purposes of clarity and understanding, shows only a base or local node 100 and one remote node 200. In practice, it should be understood that there are typically a plurality of remote nodes and that, at any given time, they may be connected or disconnected from the set of nodes forming the distributed system. Likewise, there may also be a plurality of local nodes. Communication between local and remote nodes concerning resource availability and status is carried out between Proxy Resource Manager 150 and Proxy Resource Agent 250 residing on remote node 200. Proxy agent 250 manages and controls a plurality of resources. The nature of these resources is typically quite heterogeneous in that it ranges from ports to files to devices. Proxy Resource Agent 250 creates and maintains Table 265. For each resource, Res1 (reference numeral 201) through ResM (reference numeral 209), Proxy Resource Agent 250 provides a Table 265 entry. For each resource entry, there is also provided a resource generation number (RGN₁, RGN₂, . . . , RGNₘ; reference numeral 201, 202, . . . , 209, respectively) or other indicia. A more detailed description for this indicia is provided below. Additionally, in Table 265 for each resource listed, there is also provided an attribute and/or status value. On the other hand, Table 165 contains only the association of between RGN and the resources. Proxy Agent 250 interacts with the remote resources to insure that Table 265 is updated in a timely fashion.

In preferred embodiments of the present invention, Proxy Resource manager 150 is designed to interact with existing software infrastructures for resource management. In a preferred installation the present invention is employed on an IBM pSeries data processing system, such as those manufactured and marketed by the assignee herein (and formerly referred to as the RS/6000 series of machine). These systems include RSCT (Reliable Scalable Cluster Technology) which includes a RMC (Resource Management and Control) subsystem. The RSCT/RMC infrastructure consists of a RMC subsystem and multiple resource managers on one or more nodes. The RMC subsystem provides a framework for managing and manipulating resources within a system or cluster. The framework allows a process on any node of the cluster to perform an operation on one or more resources elsewhere in the cluster.

A client program specifies an operation to be performed and the resources it has to apply through a programming interface called the RMCAPI. This is an already existing component on the aforementioned pSeries of machines. The RMC subsystem then determines the node or nodes that contain the resources to be operated on, transmits the requested operation to those nodes, and then invokes the appropriate code on those nodes to perform the operation against the resources. The code that is invoked to perform the operation is contained in a process called a resource manager.

As used herein, a resource manager is a process that maps resource type abstractions into the calls and commands for one or more specific type of resource. A resource manager is capable of executing on every node of the cluster where its resources exist. The instances of the resource manager process running on various nodes work in concert to provide mappings and translations for the above-mentioned calls and commands. To monitor and control the remote resources located on nodes that do not include a resource management infrastructure, the present invention employs Proxy Resource Manager 150, referred to herein as PxRM, which is placed on a RMI node. Its peer agent, called Proxy Resource Agent 250, or PxRA, is placed on an external entity, that is, on a non-RMI node, or device. PxRM 150 is a resource manager which connects to both RMC (Resource Management and Control) subsystem and to PxRA 250. The resources seen by PxRM 150 are the representations of the resources provided by PxRA 150. PxRA 150 can take several forms. For example, it may be an intermediate process or even a service routine. Its function is to keep track of resources 201-209 and to report changes to PxRM 150.

To provide persistent and consistent attribute values for resources 201-209, Proxy Resource Manager 150 keeps track of the status of PxRA 250, even after PxRM 150 is restarted. In order to take care of such an activity, an indicator referred to herein as a Resource Generation Number (RGN) is introduced. Each resource on a remote node has a RGN. The RGN is changed at appropriate times (see below) and traced by both PxRM 150 and PxRA 250 so that PxRM 150 “knows” the current status of the resource attributes.

A Resource Generation Number is unique in time per the resource. In other words, two RGNs are different if they are created at the different times. This property guarantees there is no state ambiguity in determining whether a Resource Generation Number changed or not. Hence a Resource Generation Number is preferably something as simple as a time stamp. However, it is noted that the Resource Generation “Number” may in general include any indicia which is capable of having an order relation defined for it. Integers and time stamps (including date and time stamps) are clearly the most obvious and easily implemented of such indicia. Accordingly, it is noted that reference herein to RGN being a “number” should not be construed as limiting the indicia to one or more forms of number representations. Additionally, it is noted that where herein it is indicated that the RGN is incremented, there is no specific requirement that the increment be a positive number nor is there any implication that the ordering or updating of indicia has to occur in any particular direction. Order and comparability are the desired properties for the indicia. Time stamps are merely used in the preferred embodiments.

The following is a description how this invention works in the desired cases. FIG. 1 is a schematic drawing showing relationships and interactions amongst the various components of the present invention. The discussion below provides a description of the operation of the components under various operational circumstances and conditions.

### Startup of Proxy Resource Agent (Remote Node)

A Resource Generation Number for each device (resource) is generated for each device (resource) whenever a device (resource) becomes active. If possible, each device is preferably responsible for maintaining its own Resource Generation Number on the remote node (node 200, for example). Additionally, a new Resource Generation Number is generated when a remote node (which includes Proxy Resource Agent 250) boots up. In either case, a new Resource Generation Number is assigned to all of the resources on remote node 200. This indicia is provided to other nodes by operation of Proxy Resource Agent 250. This process ensures that Proxy Resource Manager 150 can detect failures of a remote node and failures at a remote node. When a new Resource Generation Number is generated, Proxy Resource Agent 250 tracks this fact by maintaining entries in Table 265. Proxy Resource Agent 250 is then able to monitor the resource and is thereby able to service resource related requests sent to it from Proxy Resource Manager 150.

### Resource Goes Down in the Remote Node

If the resource itself on the remote node is down while Proxy Resource Agent 250 is still working, Proxy Resource Agent 250 simply changes the OpState.

### Resource Comes Up in the Remote Node

As described in “Startup of Proxy Resource Agent” above, a new Resource Generation Number for the resource is assigned. The reason for carrying out this step are as follows. If a new Resource Generation Number is not generated and if the resource on a remote node goes down and then comes up while the Proxy Resource Manager is down, then the Resource Generation Number on the remote node stays the same even after the Proxy Resource Manager comes back up. The Proxy Resource Manager would then consider that the resource has been kept up, which would not be incorrect; hence, this is the reason for the generation of a new indicia.

### Services of the Proxy Resource Agent (Remote Node)

If Proxy Resource Agent 250 receives a connection request from Proxy Resource Manager 150, it first replies by sending the current Resource Generation Number to Proxy Resource Manager 150, and then sends the current values of the resource's attributes, so that both can be checked for synchronization. After the establishment of a session (connection) between PxRM 150 and PxRA 250, the PxRA 250 sends only the changed attribute values to PxRM 150. If the connection is broken, PxRA 250 stops sending change information to PxRM 150.

### Startup of Proxy Resource Manager (Node), or Reconnection of PxRM to PxRA

When Proxy Resource Manager 150 on node 100 starts or reconnects to Proxy Resource Agent 250 on node 250, it first reads the Resource Generation Number from Table 165 maintained on local persistent storage 160. This number is the last generation number known to Proxy Resource Manager 150 at the last time it was communicated from Proxy Resource Agent 250. If this is the first time that Proxy Resource Manager 150 is started, the local generation number is set to null (or zero). After that, Proxy Resource Manager 150 tries to contact Proxy Resource Agent 250 on remote node 200. If successful, Proxy Resource Manager 150 receives the current Resource Generation Number for each resource from Proxy Resource Agent 250 and compares the two generation numbers (the local one and the newly received one). If they are different, it is determined that Proxy Resource Agent 250 has either been restarted or that the resource on the remote node is down or has failed while Proxy Resource Manager 150 was inactive, and thus the associated resource is marked as down_or_failed (or stale if down_or_failed is not supported). If the Resource Generation Numbers are same, Proxy Resource Agent 250 is determined to have been up and thus the resource state is still valid.

After a new generation number is received, it is stored in persistent storage 160. If the connection is not successful, Proxy Resource Manager 150 waits for a predetermined period of time, such as 10 seconds. However, this value is not critical; it depends on the implementation. The only impact that this value has occurs after the very first initial connection in those cases in which the remote node is not ready and in which it tries again to reconnect, as described above. It is not even critical if the wait time is as small as 3 seconds. After the connection, Proxy Resource Manager 150 receives the changed resource attribute values from the remote nodes, and updates the local resource attributes which are reported through RMI infrastructure 190 to the applications. If it detects a disconnection from Proxy Resource Agent 250, it tries again to connect, as described above. Note that this step does not change any of the resource attributes. Also note that, whenever a new Resource Generation Number is received, the number is stored in persistent storage 160. In this way, any failure of the bottom resources (that is, the devices), the proxy agent, or the proxy manager, is properly handled by presenting consistent attribute values.

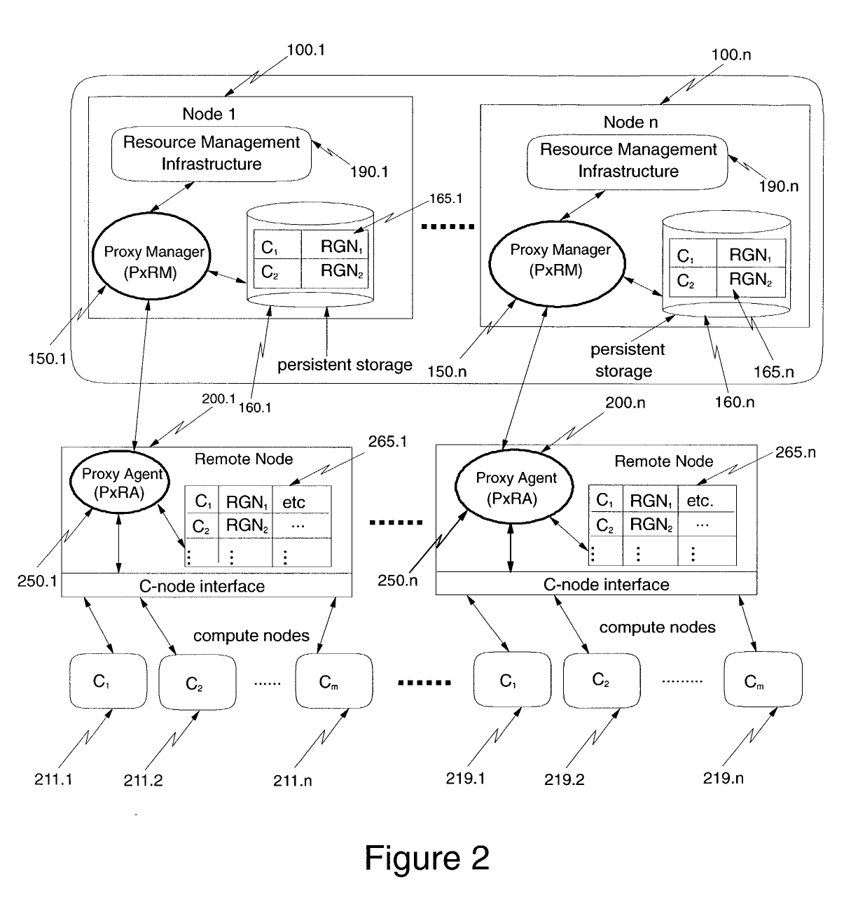

FIG. 2 illustrates an environment in which the present invention is particularly useful. The environment shown is essentially a plurality of the systems shown in FIG. 1 connected in parallel. The fact that there are a plurality of RMI supported nodes together with remote nodes that do not have RMI support means that there are a number of resources whose availability is enhanced through the use of Proxy Resource Managers 150.1-150.n and Proxy Resource Agents 250.1-250.n. The system illustrated in FIG. 2 comprises many nodes with RMI support (190.1-190.n), and an I/O node which is attached to each RMI node (100.1-100.n). Many specialized resources (called compute nodes, 211.1-219.n) are monitored through I/O nodes 200.1-200.n. Data processing systems such as this are enhanced through the use of the present invention by the placement of a Proxy Resource Manager on each RMI node, and a Proxy Resource Agent on each I/O node. The Proxy Resource Agent maintains its associated resources which includes compute nodes 211.1-219.n, as shown. Each I/O node 200.1-200.n monitors its attached compute nodes 211.1-219.n and serves as a Proxy Resource Agent for the resources attached to the I/O node and also for the compute nodes.

While the invention has been described in detail herein in accord with certain preferred embodiments thereof, many modifications and changes therein may be effected by those skilled in the art. Accordingly, it is intended by the appended claims to cover all such modifications and changes as fall within the true spirit and scope of the invention.

The invention claimed is:

1. A method for managing a remotely accessible resource in a multinode, distributed data processing system, said method comprising the steps of:
running a proxy resource manager on a first node of said system and storing therein, in a persistent storage device coupled to said first node, a sequential resource generation identifier which is associated with said remotely accessible resource;
running a proxy resource agent on at least one other node and maintaining therein a local version of said sequential resource generation identifier associated with said resource together with a status for said resource;
incrementing said local identifier version, via said proxy resource agent, upon change in resource status; and
comparing said local and said persistent identifiers for said resource to insure consistency of said status of said resource.

2. The method of claim 1 wherein said resource is selected from the group consisting of ports, databases, executable programs, storage devices and files.

3. The method of claim 1 wherein said sequential resource generation identifier is a number.

4. The method of claim 1 wherein said steps are carried out for a plurality of resources.

5. The method of claim 1 in which there are a plurality of other nodes.

6. The method of claim 1 in which said incrementing of said persistent identifier is carried out by said proxy resource manager.

7. The method of claim 6 in which incrementing is carried out by adding a negative number.

8. A computer readable medium having computer executable instructions for causing a data processor to manage a remotely accessible resource in a multinode, distributed data processing system, by carrying out the steps of:
running a proxy resource manager on a first node of said system and storing therein, in a persistent storage device coupled to said first node, a sequential resource generation identifier which is associated with said remotely accessible resource;
running a proxy resource agent on at least one other node and maintaining therein a local version of said sequential resource generation identifier associated with said resource together with a status for said resource;
incrementing said persistent identifier upon restart of said first node;
incrementing said local identifier version, via said proxy resource agent, upon change in resource status; and
comparing said local and said persistent identifiers for said resource to insure consistency of said status of said resource.
